(19) United States
(12) Patent Application Publication
(10) Pub. No.: US 2009/0120304 A1
(43) Pub. Date: May 14, 2009

(54) Apparatus for Cooking Food

(75) Inventors: Haruki Ishino, Ishikawa (JP); Yoshiharu Ito, Ishikawa (JP); Shigeru Kubo, Ishikawa (JP)

Correspondence Address: CHAPMAN AND CUTLER, 111 WEST MONROE STREET, CHICAGO, IL, 60603, US

(73) Assignee: Ishino Seisakusyo Co., Ltd, Kanazawa-shi (JP)

(21) Appl. No.: 11/991,524

(22) PCT Filed: Aug. 30, 2006
(86) PCT No.: PCT/JP2006/317073

§ 371 Date: Jun. 19, 2008

(30) Foreign Application Priority Data
Sep. 7, 2005 (JP) 2005-259732

(51) Int. Cl. A47J 27/14

(52) U.S. Cl. 99/443 C; 99/352; 99/477

(57) ABSTRACT

An apparatus for cooking food capable of quickly regulating the temperature in a housing and not causing uneven heating of food in the housing in the temperature regulation. The apparatus (50) has a housing (1) having a heater (20) in it and provided at a predetermined place in a conveyance route formed by a conveyor (49). The apparatus (50) heats food (E) to be heated by causing it to be conveyed and pass in the housing (1). An air supply opening (1f) is formed in a predetermined place of the housing (1), an air blower (48) is connected to the air supply opening (1f), and outside air can be supplied to the inside of the housing (1) by the air blower (48) via the air supply opening (1f). When the outside air is supplied from the air supply opening (1f), the air in the housing (1) is discharged from an entrance/exit (6, 6′) for the food (E) formed in the housing (1).

### TECHNICAL FIELD

The present invention relates to an apparatus for cooking food where food to be cooked, such as raw eggs, is cooked while being carried on a conveyor.

### BACKGROUND TECHNOLOGY

In order to mass produce cooked food (particularly semi-boiled eggs and hard-boiled eggs) consumed in large amounts in restaurants and the like according to the prior art, a large number of raw eggs are cooked using a cooking apparatus having a conveyor and a heater devised by the present applicant, instead of conventional boiling systems which has poor efficiency in production.

A number of rollers are aligned on the support of this cooking apparatus in the direction of conveyance, and the end portions of the respective rollers on the left and right are connected with endless chains, and thus, the rollers are provided in such a manner to be rotatable and drivable. A housing is provided in the middle of the support with a number of ceramic heaters located above the rollers, and an air blowing box having a large number of air blowing nozzles is provided above the ceramic heaters, and an air blowing fan is provided above the air blowing box so that when a number of raw eggs are placed on the rollers and moved through the rotation of the rollers, the raw eggs are conveyed into the housing while being rotated between the rollers. The raw eggs are cooked by the heat radiated from the number of ceramic heaters and the air jetted through the air blowing nozzles and heated by the ceramic heaters while passing through the housing, and the hot air is circulated inside the housing by the air blowing fans so that the hot air circulates inside the housing and the entirety of each raw egg is heated, and thus processed. When the eggs are fed out to the front of the support, they are semi-boiled eggs or hard-boiled eggs (see for example Patent Document 1).

Patent Document 1: Japanese Unexamined Patent Publication 2004-57598

### DISCLOSURE OF THE INVENTION

### Problem to be Solved by the Invention

In the cooking apparatus described in the above Patent Document 1, however, the temperature within the housing is adjusted mainly when the heating temperature of the ceramic heaters is adjusted, and therefore, it is difficult to rapidly lower the temperature within the housing by lowering the heating temperature of the ceramic heaters in cases where the temperature within the housing is temporarily high.

Therefore, the present applicant provided an air outlet which connects to the outside in an upper portion of the housing, so that air can be naturally discharged or discharged by a blower through damper control when the temperature within the housing is temporarily high, and air is taken in from the outside through the inlet and outlet for eggs in the housing, and thus, the temperature within the housing is lowered, and the temperature within the housing is adjusted so as to remain constant. However, when the temperature is adjusted through discharge of air, air comes into the housing through the inlet and outlet, and therefore, the temperature in the vicinity of the inlet and outlet becomes significantly low in comparison with other portions, and thus, the heating area within the housing becomes small, and there is a risk that the eggs may be cooked unevenly.

The present invention is provided focusing on this problem, and an object of the invention is to provide an apparatus for cooking food where the temperature within the housing can be rapidly adjusted and food can be prevented from being cooked unevenly inside the housing while the temperature is adjusted.

### Means for Solving Problem

In order to solve the above describe problem, the apparatus for cooking food according to Claim 1 of the present invention is an apparatus for cooking food having: a conveyor which can convey food to be cooked; and a housing which is placed in a predetermined location along a path of conveyance formed of the conveyor so as to cover the above described conveyor and provided with a heater for cooking food to be cooked which is conveyed by the above described conveyor inside, characterized in that

an air inlet is created in a predetermined location in the above described housing, and an air blower is connected to the air inlet so that the air blower can supply air into the above described housing from the outside through the above described air inlet, and air inside the housing is discharged through an inlet and an outlet for food to be cooked created in the above described housing when air is supplied from the outside through the above described air inlet.

According to these characteristics, in the case where the temperature within the housing increases as a result of the heating by the heaters, the air blower supplies air into the housing from the outside through the air inlet so that the temperature within the housing can be rapidly lowered, and therefore, the temperature within the housing can be efficiently adjusted, and at the same time, the air inside the housing is discharged through the inlet and outlet for food to be cooked when air is supplied from the outside so that the temperature lowers, and therefore the temperature can be kept constant throughout the entirety inside the housing without causing the temperature to lower in the vicinity of the inlet and outlet for food inside the housing as in the prior art, where air enters the housing through the inlet and outlet for food, and thus, it becomes difficult for food to be cooked unevenly.

The apparatus for cooking food according to Claim 2 of the present invention is the apparatus for cooking food according to Claim 1, wherein the above described heater is placed above the above described path of conveyance inside the above described housing, and the above described air inlet is created at least above the above described heater.

According to these characteristics, air is supplied from the outside through the air inlet, and thus, hot air which stays in the upper portion within the housing is forcefully discharged, and therefore, the temperature inside the housing can be effectively lowered.

The apparatus for cooking food according to Claim 3 of the present invention is the apparatus for cooking food according to Claim 1 or 2, wherein a means for dispersing outside air which disperses and supplies air supplied from the outside through the air inlet inside the housing is provided in the above described air inlet or in the vicinity of the air inlet inside the above described housing.

According to these characteristics, outside air supplied through the air inlet is dispersed and supplied into the housing by the means for dispersing outside air, and therefore, the temperature can be lowered uniformly throughout the entirety of the inside of the housing.

The apparatus for cooking food according to Claim 4 of the present invention is the apparatus for cooking food according to Claim 3, wherein the above described means for dispersing outside air is a louver plate which is placed in the vicinity of the above described air inlet and supplies air from the outside toward the above described inlet and outlet for food.

According to these characteristics, outside air supplied through the air inlet can be prevented from being blown directly onto the food to be cooked, and in addition, air supplied from the outside is guided to the inlet and outlet for food, and thus, the temperature can be lowered uniformly throughout the path of conveyance in the longitudinal direction within the housing, without a number of air inlets being provided, and therefore, it becomes difficult for food to be cooked unevenly.

The apparatus for cooking food according to Claim 5 of the present invention is the apparatus for cooking food according to any of Claims 1 to 4, wherein a number of housings which are the same as the above described housing are placed along the above described path of conveyance in such a manner that the inlet and outlet for food of adjacent housings are at a distance from each other.

According to these characteristics, food can be conveyed through housings, in each of which the temperature for heating is set at a different temperature, instead of heating food within a single housing by changing the temperature for heating so that the food to be cooked can be heated step by step while being conveyed, and in addition, the inlet and outlet for food of adjacent housings are at a distance from each other, and thus, it becomes difficult for air discharged from one housing to enter another housing, and therefore, the temperature is not affected between adjacent housings, even in the case where air is individually supplied into the housings from the outside.

The apparatus for cooking food according to Claim 6 is the apparatus for cooking food according to Claim 5, wherein the above described number of housings are placed in such a manner that the inlet and outlet for food of adjacent housings do not face each other.

According to these characteristics, it becomes difficult for air discharged from one housing to enter another housing, and therefore, the temperature is not affected between adjacent housings, even in the case where air is individually supplied into the housings from the outside.

### BRIEF DESCRIPTION OF THE DRAWINGS

FIG. 1 is a side diagram showing an image of the entirety of the apparatus for cooking food according to the first embodiment of the present invention;

FIG. 2 is a cross sectional diagram showing the inside of the cooking apparatus along line A-A in FIG. 1;

FIG. 3 is a perspective diagram showing an air blowing box provided with a number of cylinders for circulating a current;

FIG. 4 is a cross sectional diagram along line B-B in FIG. 2;

FIG. 5 is a schematic side diagram showing the cooking apparatus according to the second embodiment of the present invention; and

FIG. 6 is a schematic plan diagram showing the cooking apparatus according to the third embodiment of the present invention.

### EXPLANATION OF SYMBOLS

1 housing
1a side plate
1b support plate
1c front plate
1d rear plate
1e upper plate
1f air inlet
2 bottom plate
3 guide rail
4 bracket
5 chain
6 outlet (inlet/outlet)
6′ inlet (inlet/outlet)
7 support
8 sprocket
9 motor
10 drive sprocket
11 drive chain
12 annular trench
13 roller
14 support rail
15 friction material
16 attachment beam
17 horizontal support beam
18 long hole
20 heater
22 air blowing box
22a bottom plate
22b upper plate
23 air blowing nozzle
24 opening for blowing air
25 motor
25a rotational axis
26 air blowing fan
28 second louver plate (means for dispersing outside air, louver plate)
28a suspension beam
29 cylinder for circulating a current
31 suspension beam
39 handle
40 control apparatus
41 connection unit
46 first louver plate (means for dispersing outside air)
47 bottom plate
47a air hole (means for dispersing outside air)
48 air blower
49 conveyor (first embodiment)
49′, 49″ conveyor (second and third embodiments)
50 cooking apparatus (first embodiment)
50′, 50″ cooking apparatus (second and third embodiments)
E raw egg (food)

### BEST MODE FOR CARRYING OUT THE INVENTION

Embodiments of the present invention are described in the following.

### First Embodiment

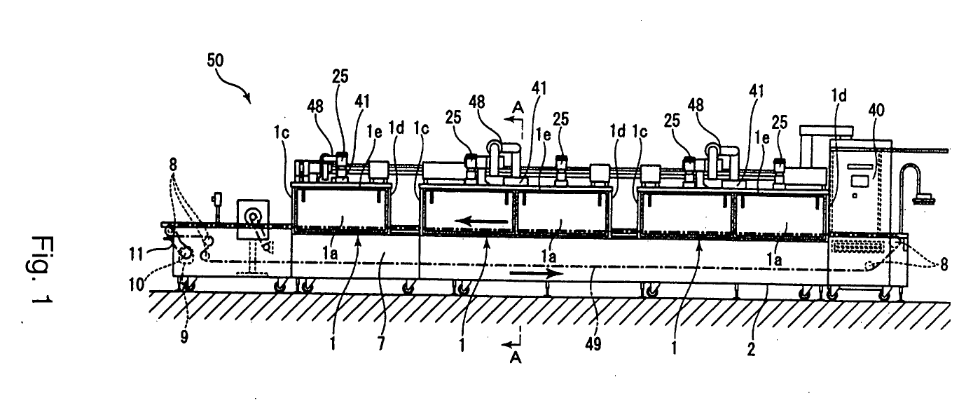

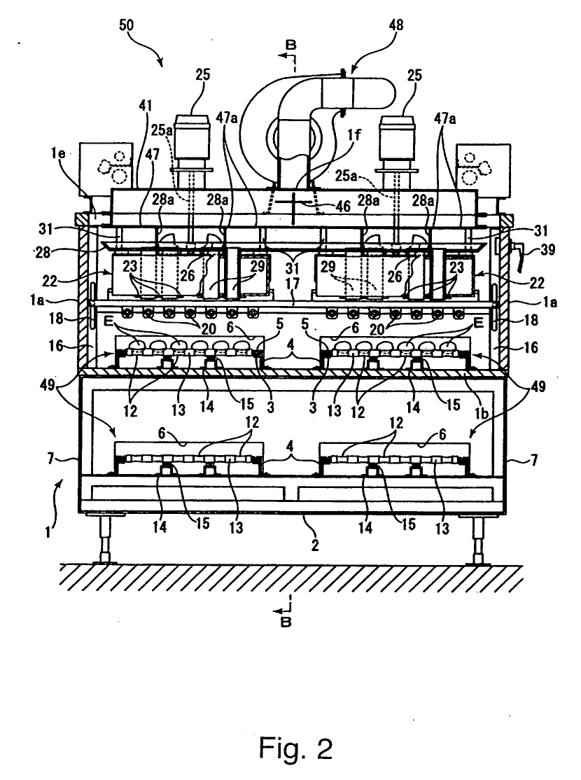

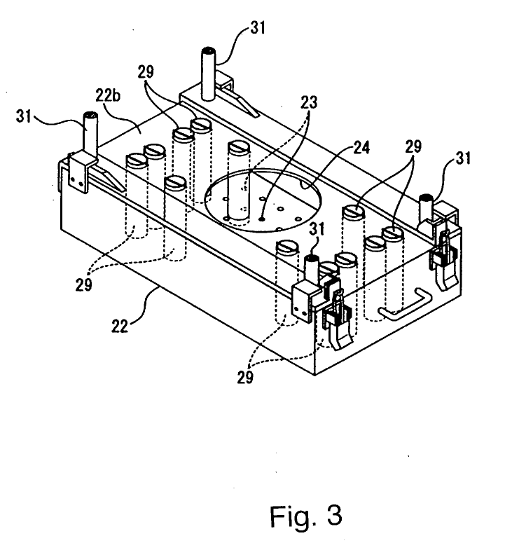

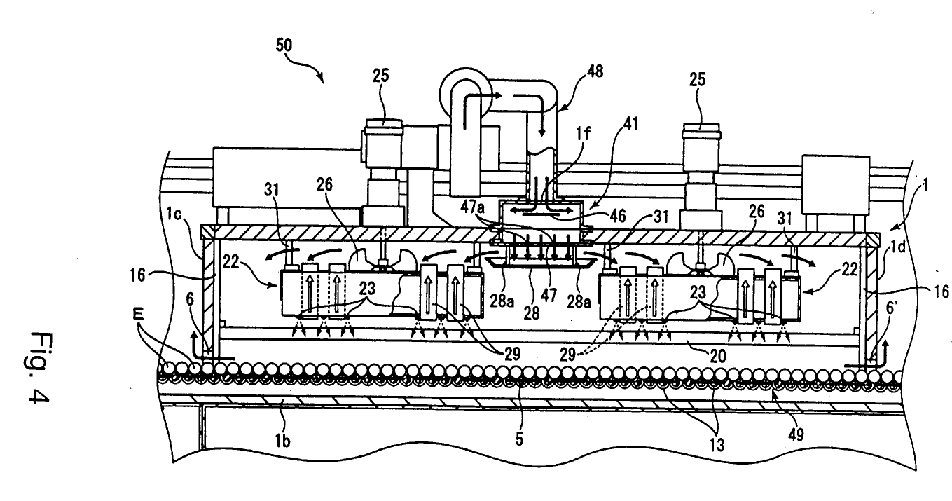

FIG. 1 is a side diagram showing an image of the entirety of the apparatus for cooking food according to the first embodiment of the present invention, FIG. 2 is a cross sectional diagram showing the inside of the cooking apparatus along line A-A in FIG. 1, FIG. 3 is a perspective diagram showing an air blowing box provided with a number of cylinders for circulating a current, and FIG. 4 is a cross sectional diagram along line B-B in FIG. 2. This cooking apparatus 50 is used when large quantities of food, for example raw eggs, are cooked and processed in sequence, and the food to be cooked is raw eggs E in the present embodiment. Here, the left side in FIG. 1 is the front side of the cooking apparatus 50, and the right side is the rear side of the cooking apparatus 50 in the following description.

As shown in FIG. 1, the cooking apparatus 50 is mainly formed of a conveyor 49 which can convey raw eggs E and a number of housings 1 in rectangular box form (three in the present embodiment) which are placed in predetermined locations along the path of conveyance formed of the conveyor 49 so as to cover the conveyor 4 from above. The conveyor 49 is provided on the support 7, which is placed on the floor, in the longitudinal direction (left-right direction in FIG. 1) in such a manner as to have elements which are freely rotatable, and two conveyors 49 are aligned on the support 7 in the left-right direction so that two paths of conveyance are formed on the upper surface of the support 7 (see FIG. 2).

The conveyors 49 run around sprockets 8, 8, which are attached in the left-right direction in the upper and lower portions of the front and rear portions of the support 7 in such a manner as to be rotatable around the axis, and a drive sprocket 10 is controlled by a motor 9 provided in the front end portion of the support 7 on the basis of a control signal from a control apparatus 40 provided in the rear end portion of the support 7, and at the same time, a drive chain 11 moves, and thus, power is conveyed to the conveyor 49, so that the conveyor moves endlessly in the direction of the arrow.

A motor 25 for driving the air blowing fan described below within the housing 1, a connection unit 41, which is attached at the center of the upper plate 1c in the front-rear direction in such a manner as to penetrate through the upper plate 1c and reciprocates so as to face the left and right, and a blower type fan 48 for sending outside air into the housing 1 through a duct at the center in the upper portion of this connection unit 41 in the left-right direction are provided on the upper plate 1e of each housing 1. Here, the side plate 1a of the housing 1 on the left side is formed in such a manner that it can be freely opened using a handle 39 provided on the outer surface of the side plate 1a, and when it is open, the inside of the housing 1 can easily be checked for maintenance.

In addition, an inlet 6′ (see FIG. 6) which makes it possible for raw eggs E that are conveyed on the conveyors 49 to enter into the housing 1 is created in the lower portion of the rear plate 1d of the housing 1, and an outlet (see FIG. 6) which makes it possible for raw eggs E that pass through the housing 1 to exit from the housing 1.

That is to say, each housing 1 is installed in such a manner as to cover a predetermined portion of the two paths of conveyance formed of the two conveyors 49 so that raw eggs E, which are food to be cooked and conveyed on the conveyors 49, enter each housing 1 through the inlet 6′ so as to be heated to a predetermined temperature while passing through the inside, and then exit from the outlet 6.

In the present embodiment, in terms of the temperature for heating inside each housing 1, the temperature is set at 70° C. in the rear housing, the temperature is set at 85° C. in the middle housing, and the temperature is set at 60° C. in the front housing, and the temperature within each housing 1 is constantly sensed by a temperature detecting sensor, not shown, which is installed in each housing 1. Here, it is possible to change the setting of the temperature for heating in each housing 1, so that the temperature for heating can be set to an appropriate temperature in accordance with the characteristics and the size of the food to be cooked by the cooking apparatus 50.

In the case where the temperature within the housing 1 exceeds the above described set temperature, for example, the temperature is adjusted to an appropriate temperature for each housing 1 by means of the temperature adjusting control described below. Here, in the present embodiment, the fan 48, the motor 25 and the control for driving the heater described below in each housing 1 are managed by one control apparatus 40 in accordance with the present embodiment, but the present invention is not limited to this, and a control apparatus may be individually provided in each housing 1 so that they can be individually and independently controlled in the configuration.

The two conveyors 49 are aligned in parallel in the direction of conveyance, as described above, so that many raw eggs E can be cooked and processed. A pair of brackets 4, 4 on the right and left having guide rails 3 in L shape on the facing surfaces are secured on the support plate 1b, which crosses between the side plates 1a on the left and right of the housing 1, and on the upper surface of the bottom plate 2 of the support 7 so as to face the front-rear direction, and a pair of endless chains 5, 5 on the right and left are engaged in such a manner as to be slidable in the front-rear direction along each guide rail 3.

A great number of rollers 13 having a number of annular trenches 12 which are portions for holding food on the outer surface are supported between the surfaces facing the chains 5 on the left and right side at both ends in such a manner as to be freely rotatable around the axis, and the chains and the great number of rollers 13 form a roller type conveyor.

In addition, two support rails 14 facing the front-rear direction are placed beneath the rollers 13 of the conveyors 49 on the left and right, respectively, and a friction material 15, such as rubber, is secured on the upper surface of these support rails 14, so that two portions in the center on the lower surface of each roller 13 make contact with the upper surface of the friction material 15, and thus, each roller rotates around the axis and moves forward, and raw eggs E which are placed on these also rotate.

Next, the internal structure of the housing 1 is described in reference to FIG. 2. The left and right ends of a pair of horizontal support beams 17, 17, one on the front and one on the rear, are attached in the middle portion of an attachment beam 16 which faces the up-down direction and is attached on the respective inner surfaces of the front plate 1c and the rear plate 1d at the two ends, left and right, through long holes 18 in such a manner that the height is adjustable above the support plate 1b, and ceramic heaters in pipe form (hereinafter abbreviated to “heaters 20”) facing the direction of conveyance are aligned at predetermined intervals in the left-right direction on the pair of horizontal support beams 17, 17, one on the front and one on the rear. Here, according to the present embodiment, each heater 20 is placed directly above a portion between adjacent annular trenches 12 in each roller 13, so that heat from the heater can be efficiently conveyed to the raw eggs E on the left and right side.

As shown in FIGS. 2 to 4, an air blowing box 22 in flat, rectangular parallelepiped form is hung from the upper plate 1e via a support beam 31 in rod form above each heater 20. A great number of air blowing nozzles 23 which are connected to the air blowing box 22 are attached on the lower surface of the bottom plate 22a of the air blowing box 22 at constant intervals in the front-rear direction in such a manner as to face the space between the adjacent heaters 20 and the track where the center between the annular trenches 12 in the rollers 13 moves.

An air inlet 1f for supplying outside air into the housing 1 is created at the center of the upper plate of the connection unit 41 in box form which is attached to the upper surface plate 1e, and a fan 48 is connected to the air inlet 1f. A number of air holes 47a, which are an example of a means for dispersing outside air for dispersing outside air supplied through the air inlet 1f and making it flow into the housing 1, are created in the bottom plate 47 of the connection unit 41. In addition, a circular first louver plate 46, which is an example of a means for dispersing outside air which disperses outside air supplied through the air inlet 1f, is provided beneath the air inlet 1f inside the connection unit 41.

Furthermore, a second louver plate 28, which is an example of a means for dispersing outside air and has approximately the same shape as the bottom plate 47, is hung from the lower surface of the bottom plate 47 with a number of suspension beams 28a in rod form beneath the bottom plate 47. That is to say, as shown in FIG. 2, the second louver plate 28 is placed in such a manner as to cross the two conveyors 49 on the left and right above the conveyors 49.

Next, the air blowing box 22 is described in reference to FIGS. 2 and 3. A circular air blowing opening 24 is created in the center of the upper plate 22b of the air blowing box 22, and the lower end portion of the air blowing fan 26, which is attached to the rotational axis 25a hanging into the housing 1 from the motor 25 attached in the center portion on the upper surface of the upper plate 1e of the housing 1, is partially contained within this air blowing opening 24.

When the air blowing fan 26 rotates by means of the motor 25, the air inside the housing 1 is sent in from the upper surface of the air blowing box 22 and compressed, and the compressed air, of which the pressure is approximately constant within the air blowing box 22, is jetted out from the respective air blowing nozzles 23 with uniform pressure. A number of cylinders for circulating a current 29 in cylindrical form as shown in FIGS. 2 and 3 are engaged around the periphery of the air blowing opening 24 in the air blowing box 22 in such a manner as to penetrate upward and downward through the air blowing box 22, and thus, air beneath the air blowing box 22 passes through the cylinders for circulating a current 29 and circulates up and down, so that air is continuously blown by the air blowing fan 26.

Next, the working effects when raw eggs E are cooked using the cooking apparatus 50 are described. First, power is supplied to the respective heaters 20, and at the same time, the motor 25 operates so as to rotate the air blowing fan 26, and thus, the temperature within the respective housings is raised to a preset temperature. In addition, as shown in FIGS. 1 and 2, raw eggs E are placed over annular trenches 12 between the rollers 13 on the top of the support 7 on the rear side of the cooking apparatus 50, and after that, the chains 5 move at a slow speed.

When the raw eggs E are conveyed while rotating as the conveyor 49 is driven and reach a housing 1, they enter the housing 1 via the inlet 6′ created in the rear plate 1d of the housing 1. Then, as shown in FIG. 4, the raw eggs E are cooked for a predetermined period of time through heat radiated from the respective heaters 20 and hot air jetted from the large number of air blowing nozzles 23 in the air blowing box 22 while passing through the housing 1, and after leaving through the outlet 6 created in the front plate 1c, further enter into the front housing 1. Finally, the raw eggs E become semi-boiled or hard-boiled eggs after passing through the three housings 1 having different heating temperatures, and are fed out toward the front support 7 side.

The respective haters 20 face the direction in which raw eggs E are conveyed, and the air blowing nozzles 23 are located above the track on which raw eggs E are conveyed so that hot air is jetted directly against the raw eggs E, and furthermore, the pressure of air jetted from all of the air blowing nozzles 23 is kept approximately constant within the air blowing box 22, and therefore, the temperature for cooking raw eggs E becomes approximately constant in all locations, so that semi-boiled eggs or hard-boiled eggs having uniform hardness are gained. In addition, hot air heated by the heater 20 which moves upward flows into the cylinders for circulating a current 29 and moves toward the upper portion of the housing 1, and then is sent into the air blowing box 22 by means of the air blowing fan 26 so as to circulate, and therefore, the efficiency in heating is high with little heat loss.

As described above, the air inside the housing 1 is heated, and the heated air is circulated in the air blowing box 22, and thus, the entirety of the inside of the housing 1 is kept at a uniform temperature with high efficiency as time elapses. Here, when a temperature detection sensor (not shown) provided within the housing 1 detects that the temperature within the housing 1 has become the upper limit temperature and exceeds the above described set temperature, the following control for adjusting the temperature is carried out.

In the present embodiment, as shown in FIG. 4, in the case where the temperature within any of the housings 1 reaches the upper limit temperature and exceeds the above described set temperature, the fan 48 is driven so that outside air, that is, cold air, is sent into the housing 1 toward the connection unit 41, and thus, cooling control for rapidly cooling the temperature within the housing 1 is carried out.

Outside air sent out by the fan 48 is supplied into the connection unit 41 via an air inlet 1f created in the upper surface of the connection unit 41, that is, into the housing 1. Outside air from the air inlet 1f hits the first louver plate 46 and is dispersed in many directions throughout the entirety of the connection unit 41, and then uniformly jetted through the number of air holes 47a created in the bottom plate 47 so as to be dispersed toward the second louver plate 28 directly beneath the bottom plate 47. Thus, the first louver plate 46 is placed beneath the air inlet 1f, and thus, outside air from the air holes 47a located directly beneath the air inlet 1f can be prevented from being jetted in an uneven state, and outside air supplied from the air inlet 1f at the center can be uniformly jetted in the direction of the width of the conveyors 49 aligned on the left and right, due to the number of air holes 47a created in the bottom plate 47.

Outside air jetted out and downward from the number of air holes 47a hits the second louver plate 28 and is sent out so as to disperse above the front and rear air blowing boxes 22, 22, that is to say, in the longitudinal direction of the path of conveyance. As a result, outside air jetted out and downward from the number of air holes 47a can be prevented from being jetted out against the path of conveyance located beneath in an uneven state, and in addition, outside air that disperses after hitting the second louver plate 28 is guided in the direction of the path of conveyance, and therefore, the entirety of the inside of the housing 1, which extends in the longitudinal direction of the path of conveyance, can be heated uniformly, and not partially.

In addition, the air heated inside the housing 1 rises, and therefore, the air inlet 1f is created in an upper portion of the housing 1, specifically in a location above the location where the heaters 20 are placed to cook food to be cooked, and thus, hot air which stays above the housing 1 can be forcefully discharged together with outside air from the air inlet 1f so as to be cooled, and therefore, the temperature within the housing can be efficiently lowered (cooled). Thus, when outside air is taken into the housing 1, the air within the housing 1 is pushed out through the outlet 6 and the inlet 6′ created beneath the front plate 1c and the rear plate 1d and partially discharged to the outside.

In more detail, when outside air is supplied from the upper portion of the housing 1 as described above, the air inside the housing 1 is discharged through the inlet 6′ through which raw eggs E, which are food to be cooked, enter into the housing 1, and the outlet 6, through which raw eggs E exit, and thus, raw eggs E can be prevented from being unevenly cooked, unlike in the prior art, where the air inside the housing 1 is absorbed and discharged so as to be cooled, and outside air enters into the housing through the outlet 6 and the inlet 6′, and the temperature in portions in the vicinity of the outlet 6 and the inlet 6′ lowers within the housing 1, so that the distance through which raw eggs E pass becomes shorter within the housing 1.

In addition, when the temperature inside the housing 1 is lowered (cooled) through the supply of outside air, the temperature can be kept constant throughout the entirety of the inside of the housing 1, and therefore raw eggs E, which are food to be cooked, can be cooked uniformly, and thus, large quantities of food can be manufactured stably.

In addition, the outlet 6 and the inlet 6′ for food, which are created in the housing 1 in advance, are used as air outlets for discharging air inside the housing 1, and thus, it is not necessary to create a separate air outlet in addition to the outlet 6 and the inlet 6′ in the side plate 1a of the housing 1, for example, and therefore the cost of manufacture can be reduced. In addition, when a separate air outlet is created in addition to the outlet 6 and the inlet 6′, the number of openings in the housing 1 becomes great, so that the temperature inside the housing 1 is low when heat is normally applied, and the efficiency in adjusting the temperature becomes poor. The present invention does not have this problem.

Furthermore, outside air supplied through the air inlet 1f created approximately in the center in the front-rear direction (direction of conveyance) in the housing 1, which extends in the direction of the path of conveyance, flows toward the outlet 6 and the inlet 6′, that is to say, flows in the path of conveyance, and therefore, the temperature inside the housing 1 can be uniformly lowered throughout the path of conveyance in the longitudinal direction, particularly without causing any unevenness in the path of conveyance.

In addition, the first and second louver plates 46 and 28 are provided in the vicinity of the air inlet 1f, through which outside air is blown out, and thus, outside air from the fan 48 hits the respective louver plates 46 and 28, so that outside air can be dispersed and supplied into the housing 1, and therefore, outside air can be supplied uniformly into the housing 1 through one air inlet 1f, and thus, it is not necessary to create a number of air inlets 1f in the housing 1.

Furthermore, a number of air holes 47a are created in the bottom plate 47 so that outside air can be jetted into the housing 1 through air holes 47a, and therefore, outside air can be smoothly mixed with air already inside the housing and prevented from being jetted intensively in one portion, and thus, it becomes difficult for food to be unevenly cooked.

As described above, in the case where the temperature inside the housing 1 rises through heating by the heaters 20 in the cooking apparatus 50 according to the embodiment of the present invention, outside air is supplied into the housing 1 through the air inlet 1f by the fan 48, and thus, the temperature inside the housing 1f can be rapidly lowered, and therefore, the temperature inside the housing 1 can be efficiently adjusted, and at the same time, air inside the housing 1 is discharged through the outlet 6 and the inlet 6′ for raw eggs E when outside air is supplied, and thus, the temperature in the vicinity of the outlet and the inlet within the housing 1 can be prevented from lowering due to outside air entering into the housing 1 through the inlet/outlet, unlike in the prior art, and thus, the temperature can be kept constant throughout the entirety of the inside of the housing 1, and it becomes difficult for food to be cooked to be cooked unevenly.

Here, as shown in FIG. 1, the temperature is adjusted in the housings 1 in the manner described above, on the basis of the temperature adjusting control, and therefore, when outside air is supplied into any of the housings 1 so that the temperature is adjusted, air is discharged through the outlet 6 and the inlet 6′ of the housing 1. The housings 1 are placed in such a manner that the distance between the outlet 6 and the inlet 6′ of adjacent housings 1 is a predetermined distance, and therefore, it is difficult for air discharged from the outlet 6 and the inlet 6′ of one housing 1 to enter the outlet 6 or the inlet 6′ of another housing 1, and thus, air from one housing 1 can be prevented from affecting the temperature inside another housing 1, and food can be prevented from being cooked unevenly.

Accordingly, it is not necessary to cook food by changing the temperature for heating only within a single housing 1, and raw eggs E, which are food to be cooked, are simply conveyed through areas where different temperatures for heating are set (70 degrees, 85 degrees and 60 degrees in the present embodiment), and thus, raw eggs E can be cooked in steps while being conveyed, and the outlet 6 and the inlet 6′ of adjacent housings 1 are at a distance from each other, so that it becomes difficult for air discharged from one housing 1 to enter another housing 1, and therefore, even in the case where outside air is separately supplied into each housing 1, the temperature inside adjacent housings 1 is not affected.

### Second Embodiment

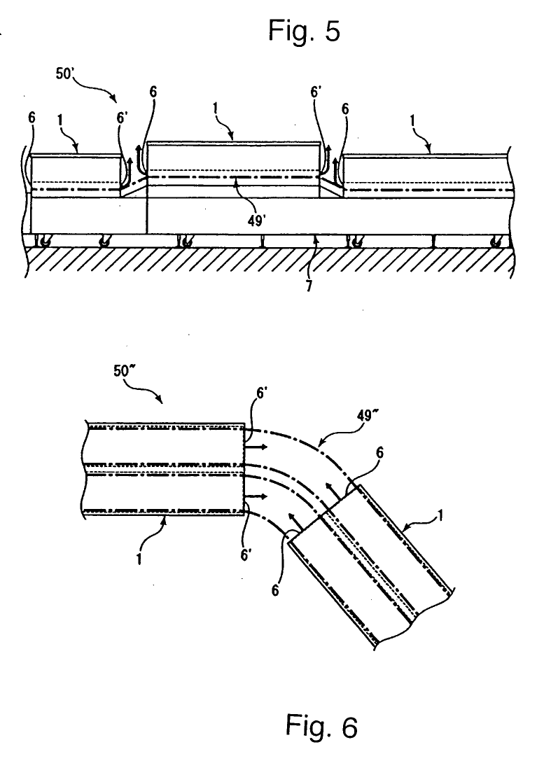

Next, the cooking apparatus 50′ according to the second embodiment of the present invention is described on the basis of FIG. 5. FIG. 5 is a schematic side diagram showing the cooking apparatus 50′. Here, in the following second embodiment, the same symbols are attached to portions having the same structure as in the above described first embodiment, and thus, detailed descriptions thereof are omitted.

As shown in FIG. 5, the cooking apparatus 50′ is provided with a number of housings 1, and adjacent housings 1, 1 are at a predetermined distance from each other along the path of conveyance for raw eggs E, and at the same time, the two housings 1, 1 have a shift in the height in the up-down direction, and thus are positioned in such a manner that adjacent outlets 6 and inlets 6′ do not face each other, and as a result, air discharged from the outlet 6 and the inlet 6′ of one housing 1 can be prevented from entering another housing 1. That is to say, it becomes difficult for air discharged from the outlet 6 and the inlet 67 of one housing 1 to enter an adjacent housing 1, and therefore, the temperature can be stably adjusted separately for each housing 1, without affecting the temperature within other housings 1.

Here, though in the present second embodiment, the outlet 6 and the inlet 6′ of adjacent housings 1 are positioned so as not to face each other by shifting the housings 1 in the height, the same working effects can be gained by positioning the outlet 6 and the inlet 6′ in such a manner that they have a shift in position in the left-right direction parallel to the path of conveyance and do not face each other, for example, though such a configuration is not shown. In addition, in this case, the path of conveyance is not inclined, and therefore, does not affect the conveyance of food to be cooked.

### Third Embodiment

Next, the cooking apparatus 50″ according to the third embodiment of the present invention is described on the basis of FIG. 6. FIG. 6 is a schematic plan diagram showing the cooking apparatus. Here, in the following third embodiment, the same symbols are attached to portions having the same structure as in the above described first embodiment, and thus, detailed descriptions thereof are omitted.

As shown in FIG. 6, the path of conveyance of a conveyor 49″ is curved in the cooking apparatus 50″, so that housings 1, 1 are installed in two portions in the curved path of conveyance in such a manner that there is an angle between the outlet 6 and the inlet 6′ of adjacent housings, and the angle is different for air which is discharged from the outlet 6 and the inlet 6′ (direction of arrows in the figure), and as a result, air discharged from the outlet 6 and the inlet 6′ of one housing is prevented from entering the other housing 1.

Though the embodiments of the present invention are described above in reference to the drawings, the concrete configuration is not limited to these embodiments, and modifications and additions in such a scope as not to deviate from the gist of the present invention are included in the present invention. Though in the above described embodiments, outside air is taken in through the air inlet 1f in an upper portion of the housing 1 so that hot air staying in the upper portion of the housing can be lowered and cooled, which is preferable, the place where the air inlet 1f is created according to the present invention is not limited to the upper surface of the housings 1, and the air inlet may be created on a side of the housing or the like.

In addition, though the outlet 6 and the inlet 6′ of adjacent housings 1, 1 are at a predetermined distance from each other in the above described embodiments, and furthermore, the housing 1 is arranged in such a manner that the outlet 6 and the inlet 67 do not face each other, an air blocking plate where a hole through which food to be cooked passes is created in a lower portion may be provided between the outlet 6 and the inlet 6′ of adjacent housings 1, 1 in such a manner as to cross the path of conveyance, and thus, air from the outlet 6 and the inlet 6′ of one housing 1 can be prevented from entering another housing 1.

In addition, though in the above described embodiments, a connection unit 41 is provided in a portion of the upper plate 1e of the housing 1 in such a manner as to be freely removable, and the fan 48 is connected via this connection unit 41, the present invention is not limited to this, and a fan may, of course, be connected directly in an opening created in the upper plate 1e without providing a connection unit 41.

In addition, though the amount of outside air taken into the housing can be finely controlled using a blower type fan 48 in the above described embodiments, which is preferable, the present invention is not limited to this, and outside air may be taken into the housing by directly providing air blowing fins in the air inlet 1f.

Here, the sequence cooking apparatus according to the present invention can, of course, be applied to heating of food other than the raw eggs E in the above description.

1-6. (canceled)

7. An apparatus for cooking food, comprising:
a conveyor for conveying food to be cooked; and
a housing positioned along a path of conveyance of the conveyor so as to cover said conveyor, said housing comprising a heater for cooking food that is conveyed into said housing by said conveyor, wherein
an air inlet is formed in said housing, and
an air blower is connected to the air inlet to supply air through said air inlet into said housing from outside of said housing, and thereby, air inside the housing is discharged through an inlet for food and an outlet for food formed in said housing.

8. The apparatus for cooking food according to claim 7, wherein said heater is positioned above said path of conveyance inside said housing, and said air inlet is positioned above said heater.

9. The apparatus for cooking food according to claim 7, further comprising a means for dispersing outside air that disperses and supplies air supplied from the outside of the housing through the air inlet inside the housing, said means for dispersing outside air being positioned in said air inlet or in a vicinity of the air inlet inside said housing.

10. The apparatus for cooking food according to claim 8, further comprising a means for dispersing outside air that disperses and supplies air supplied from the outside of the housing through the air inlet inside the housing, said means for dispersing outside air being positioned in said air inlet or in a vicinity of the air inlet inside said housing.

11. The apparatus for cooking food according to claim 9, wherein said means for dispersing outside air is a louver plate that is positioned in the vicinity of said air inlet, and that directs the air from the outside in directions toward said inlet for food and said outlet for food.

12. The apparatus for cooking food according to claim 10, wherein said means for dispersing outside air is a louver plate that is positioned in the vicinity of said air inlet, and that directs the air from the outside in directions toward said inlet for food and said outlet for food.

13. The apparatus for cooking food according to claim 7, comprising at least two of said housings positioned along said path of conveyance, wherein the housings are positioned so that the inlets for food and the outlets for food of adjacent housings are positioned at a distance away from each other.

14. The apparatus for cooking food according to claim 8, comprising at least two of said housings positioned along said path of conveyance, wherein the housings are positioned so that the inlets for food and the outlets for food of adjacent housings are positioned at a distance away from each other.

15. The apparatus for cooking food according to claim 9, comprising at least two of said housings positioned along said path of conveyance, wherein the housings are positioned so that the inlets for food and the outlets for food of adjacent housings are positioned at a distance away from each other.

16. The apparatus for cooking food according to claim 10, comprising at least two of said housings positioned along said path of conveyance, wherein the housings are positioned so that the inlets for food and the outlets for food of adjacent housings are positioned at a distance away from each other.

17. The apparatus for cooking food according to claim 11, comprising at least two of said housings positioned along said path of conveyance, wherein the housings are positioned so that the inlets for food and the outlets for food of adjacent housings are positioned at a distance away from each other.

18. The apparatus for cooking food according to claim 12, comprising at least two of said housings positioned along said path of conveyance, wherein the housings are positioned so that the inlets for food and the outlets for food of adjacent housings are positioned at a distance away from each other.

19. The apparatus for cooking food according to claim 13, wherein at least two of said housings are positioned to be offset so that the inlet for food and outlet for food of at least two adjacent housings do not face each other.

20. The apparatus for cooking food according to claim 14, wherein at least two of said housings are positioned to be offset so that the inlet for food and outlet for food of at least two adjacent housings do not face each other.

21. The apparatus for cooking food according to claim 15, wherein at least two of said housings are positioned to be offset so that the inlet for food and outlet for food of at least two adjacent housings do not face each other.

22. The apparatus for cooking food according to claim 16, wherein at least two of said housings are positioned to be offset so that the inlet for food and outlet for food of at least two adjacent housings do not face each other.

23. The apparatus for cooking food according to claim 17, wherein at least two of said housings are positioned to be offset so that the inlet for food and outlet for food of at least two adjacent housings do not face each other.

24. The apparatus for cooking food according to claim 18, wherein at least two of said housings are positioned to be offset so that the inlet for food and outlet for food of at least two adjacent housings do not face each other.
